(19) United States
(12) Patent Application Publication
(10) Pub. No.: US 2026/0192434 A1
(43) Pub. Date: Jul. 9, 2026

(54) MOVABLE AXLE HOLDER FOR MOTORCYCLE STAND

(71) Applicant: Pit Bull Products, Inc., Huntsville, AL (US)

(72) Inventor: Charles VanValkenburgh, Huntsville, AL (US)

(73) Assignee: Pit Bull Products, Inc., Huntsville, AL (US)

(21) Appl. No.: 19/425,128

(22) Filed: Dec. 18, 2025

Related U.S. Application Data
(62) Division of application No. 19/011,767, filed on Jan. 7, 2025.

(51) Int. Cl. B25H 1/00

(52) U.S. Cl. CPC B25H 1/0014

(57) ABSTRACT

The invention is directed to a motorcycle axle holder for use with a motorcycle stand. The motorcycle stand has a first cylindrical member extending from a substantially vertical cylindrical member and the motorcycle stand is configured to lift an end of a motorcycle off a surface for removal of a motorcycle axle and wheel therefrom. The motorcycle axle holder includes a main body secured around the substantially vertical cylindrical member of the motorcycle stand. The invention also includes an angle axle hole positioned in the main body and configured to receive and hold one end of a motorcycle axle.

### CROSS REFERENCE TO RELATED APPLICATIONS

The present application is a divisional application of US Application 19/011,767 filed January 7, 2025.

### BACKGROUND OF THE INVENTION

The present invention relates generally to motorcycle stands. More particularly, this invention pertains to a device that provides a storage location for the motorcycle axle and related hardware while the motorcycle wheel is removed from the motorcycle. It keeps the motorcycle axle and related hardware relatively clean by keeping them off the ground and in a location preferable to the user. The invention attaches to the motorcycle stand by clamping to a tubular portion of the stand. It can be located on the left or right side of the motorcycle stand. Further, it can be positioned at any point along the tube to a position desired by the user.

This invention uses similar holding and positioning techniques for the motorcycle axle and related components as an invention described by US patent 11,001,484 and is developed by the same inventor. The invention uses a similar cantilever approach to holding the motorcycle axle as previously mentioned invention but incorporates enhanced V-shapes to adapt to different diameter motorcycle axles and force the axle to be centered in the axle holder. It further incorporates a stop to prevent the motorcycle axle from sliding downward. This approach allows the motorcycle axle to be held regardless of whether it is hollow or solid. It is believed to be worthy of its own patent based on the evolutionary nature that will be described below.

There are motorcycle stands used for raising the front or rear wheel of the motorcycle off the ground for maintenance. With the motorcycle front or rear wheel off the ground and the motorcycle supported by the motorcycle stand, the respective front or rear wheel can be removed. Once the wheel is removed the axle and related hardware such as wheel spacers, axle nuts, washers and cotter pins and/or locking elements would otherwise not have a clean storage location. When disassembling/reassembling mechanical systems such as a motorcycle, a clean storage location can save time and aid in preventing parts from being omitted during reassembly. The present invention allows the user to position it according to his/her preferences making it most useful to his/her needs.

### SUMMARY OF THE INVENTION

The present invention is a device that attaches to a motorcycle stand to hold the motorcycle axle and all related hardware when the motorcycle wheel is being removed from the motorcycle. Uniquely, it clamps to a (nearly) horizontal or (nearly) vertical structural tube of the motorcycle stand. By clamping the axle holder to the motorcycle stand in this fashion, the user has the ability to position it to his/her desired location and position. It can also be located on the left or right side of the motorcycle stand.

The invention captures the motorcycle axle by cantilevering the axle in angled surfaces such that the axle exerts force upward near the tip and downward in an area away from the tip. The opening in which the axle is inserted is wide enough to accept the widest motorcycle axle available. The angled surfaces are each V-shaped to A) hold the axle in place regardless of size (from the largest axle diameter available down to the smallest), and B) force the axle to be centered within the axle holder. There is a vertical or nearly vertical surface for the tip of the motorcycle axle to stop against and thus prevent the axle from sliding out of containment.

### BRIEF DESCRIPTION OF THE DRAWINGS

A fuller understanding of the foregoing may be had by reference to the accompanying drawings, wherein:

FIG. 1 is a view showing the invention, a removable axle holder installed on a motorcycle stand on the lower (nearly) horizontal structural tube;

FIG. 2 is an exploded view showing the invention and its parts as they are arranged prior to installation on the motorcycle stand;

FIG. 3 is a view showing the invention in place on the motorcycle stand with the motorcycle axle and related parts as they are being inserted into the invention;

FIG. 4 is a view showing the invention installed on the motorcycle stand with the motorcycle axle and related parts stored in place;

FIG. 5 is a partial section view showing how a motorcycle axle is installed and retained on the invention;

FIGS. 6A-6C shows a side view, top view and auxiliary view of the axle holder showing the V-shaped openings designed to retain the axle regardless of diameter.

FIG. 7 shows an alternative design clamped to the (nearly) vertical structural tube; and

FIG. 8A shows an alternative design that is convertible to be attached to the (nearly) horizontal or the (nearly) vertical structural tube showing the invention attached to the nearly horizontal tube;

FIG. 8B shows the convertible design attached to the nearly vertical tube.

### DETAILED DESCRIPTION OF THE INVENTION

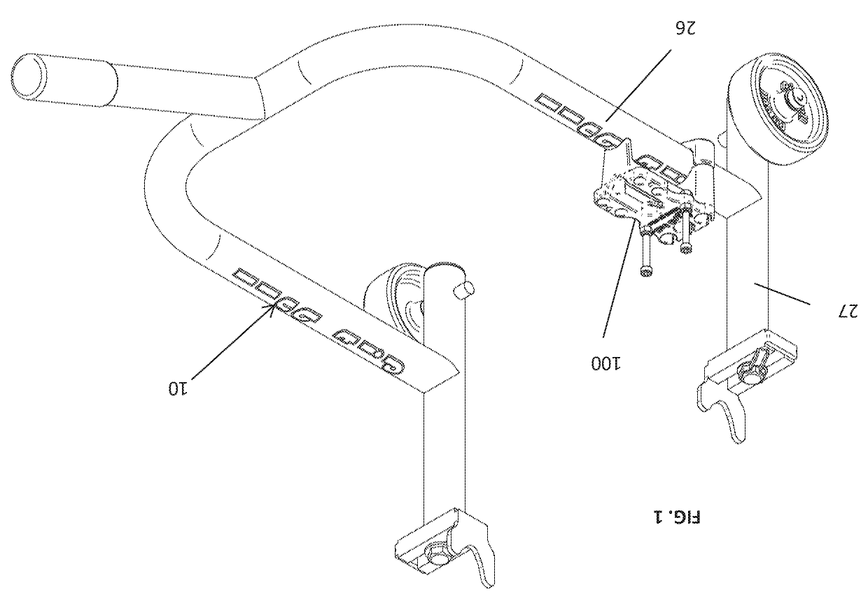

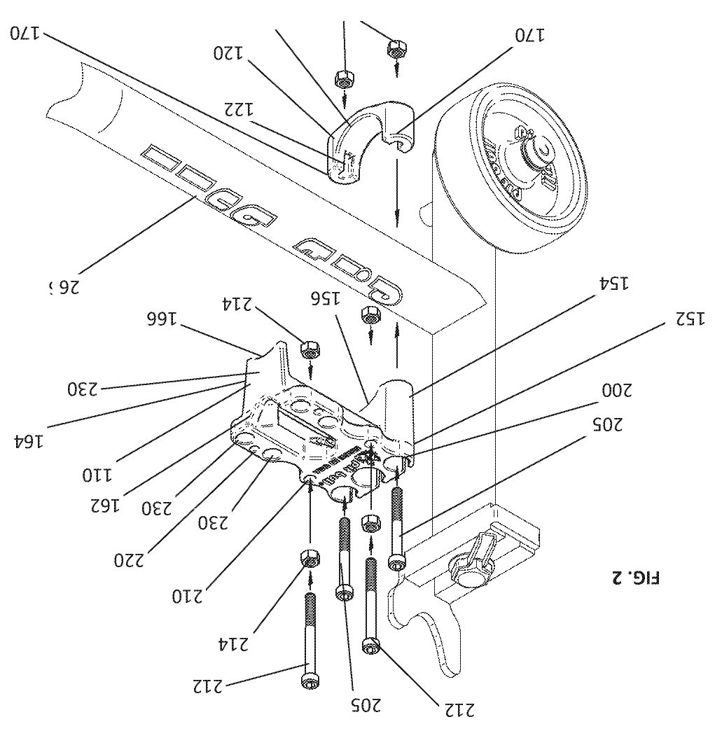

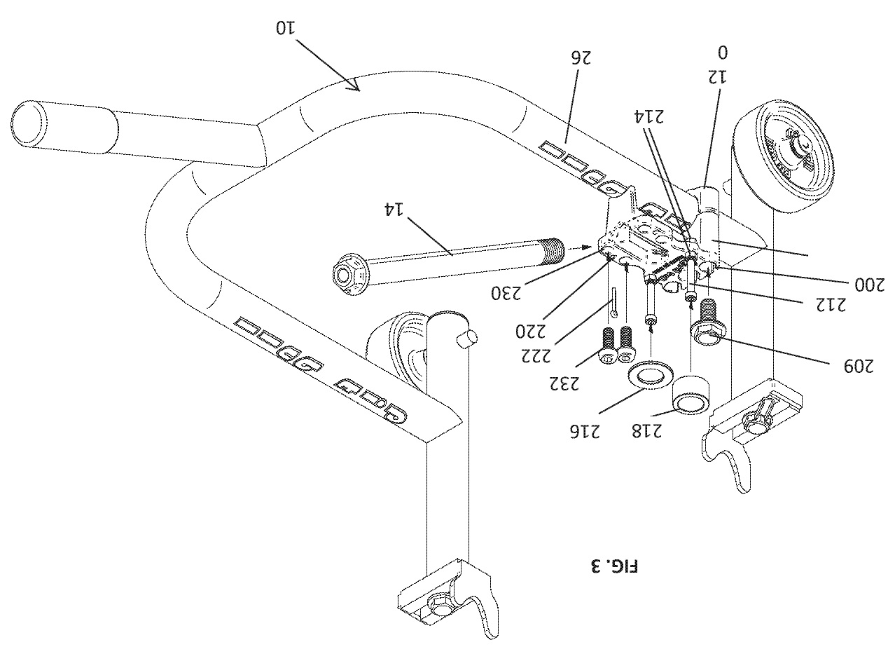

Referring to FIGS. 1-8, the present invention is a movable device 100 for retaining a motorcycle axle 14 and all related hardware while the motorcycle wheel is being removed from the motorcycle and while the motorcycle wheel is off the motorcycle.

The invention, a movable axle holder 100, is shown in FIG. 1 attached to a motorcycle stand’s 10 nearly horizontal structural tube 26. The invention 100 is comprised of a main body 110 and a clamp 120.

The main body 110 includes holes defined in the following order: a set of counterbored holes 200; a set of holder holes 210; a set of small holes 220; caliper holes 230; a blind hole 240; and an angled axle hole 250.

The main body 110 is further defined to include a frame 150 through which the various holes are bored therethrough. The frame 150 has a front end 152 and a distal rear end 162. Extending from the front end 152 includes a front leg 154, while a rear leg 164 extends from the rear end 154. Both the front leg 162 and the rear leg 164 include a concave terminal edge 156 and 166, respectively. The clamp 120 includes opposing distal edges 170 with a curved middle portion 172 between the distal edges 170. The concave terminal edges and curved middle portion are curved to sit around the perimeter of the structural tube 26.

The counterbored holes 200 receive a set of fastener screws 205 which extend into clamp holes 122 and secured by nuts 207, which fasten the main body to the clamp 120. The counterbored holes 220 are also sized to allow the front axle end screws 209 to sit in the counterbored holes 220 over the fastener screws 205. Front axle end screws 209 are screws typically used to set the front wheel spacing when the front axle is inserted into the motorcycle.

The holder holes 210 receive a second set of screws 212 secured to the main body 110 with nuts 214 that are placed on either side of the main body 110. This will maintain a defined length of the second set of screws extending above the main body 110 to receive washers 216 and spacers 218 that will be placed over the second set of screws 212 for storage.

The small holes 220 are sized to receive cotter pins 222 or other fixing devices such as wire safety pins to be inserted for storage.

Caliper holes 230 are sized to receive brake caliper screws 232. The quantity of caliper holes 230 is defined to four to account for using the invention for the front wheel of the motorcycle since motorcycles normally use a quantity of four front brake caliper screws 232.

The blind hole 240 is incorporated to accommodate screws that might be larger screws.

Depending on the make and model of the motorcycle, there are different sizes and quantities of wheel spacers 218 and washers 216. The screws 212 provide a place for these to be stored.

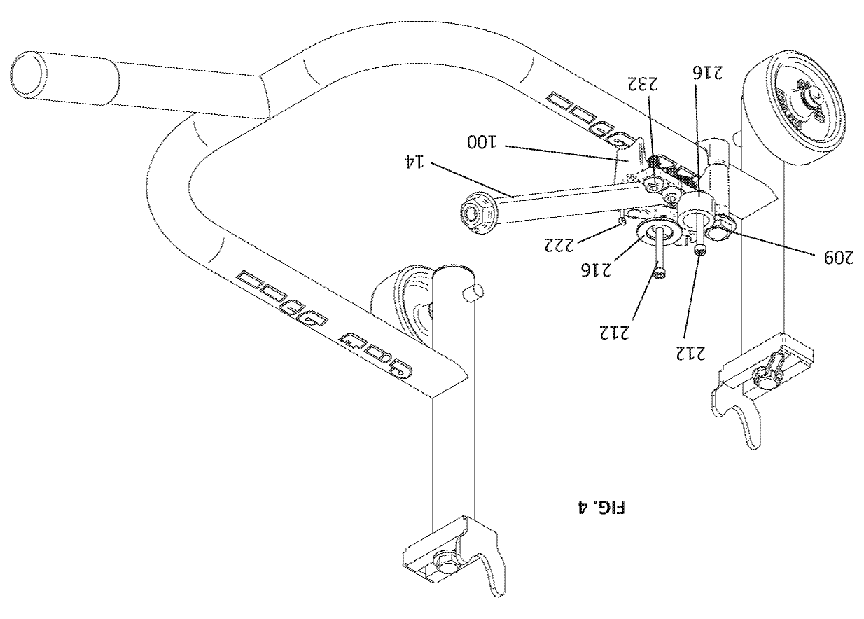

FIG. 4 shows the invention 100 in place on the motorcycle stand 10 with an axle 14 in place with a typical assortment of screws 212, spacer 218, washer 216 and a cotter pin 222. The arrow indicates that the invention could be mounted and clamped into position along the nearly horizontal structural tube 26 of the motorcycle stand 10.

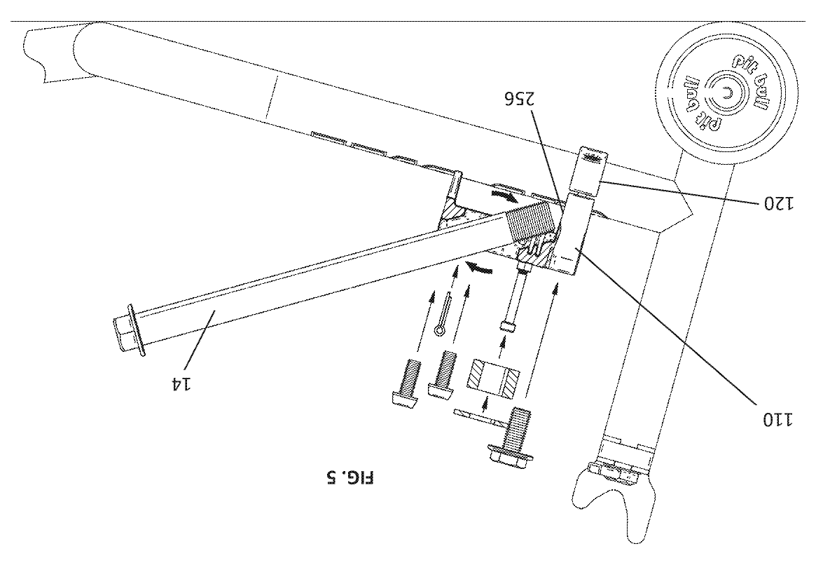

FIG. 5 is a cutaway view of the axle holder main body 110 that shows the motorcycle axle 14 in place in the angled axle hole 250. The angled axle hole 250 includes a forward angled surface 252 and rearward angled surface 254 are what allow the axle to be held in place. This is accomplished since the bulk of the axle weight is suspended past the rearward angled surface. Curved arrows indicate the opposing directions of force applied by the axle 14 to hold the axle in place. The axle holder main body 110 includes a substantially vertical surface 256 prevents the motorcycle axle 14 from sliding forward and down.

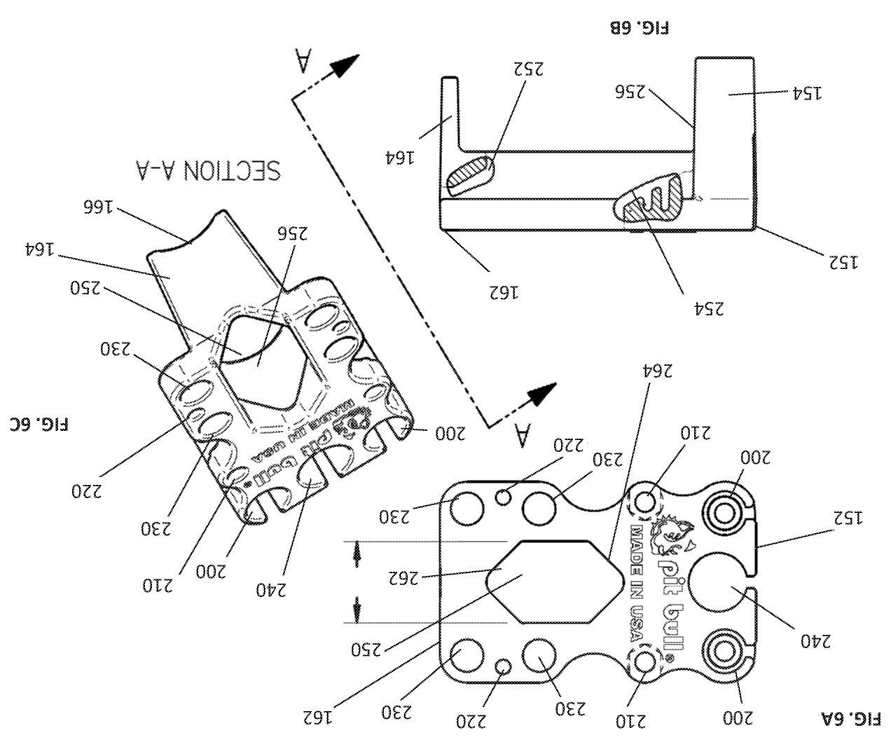

Referring to FIG. 6 there is a side view, top view and auxiliary view of the main body of the invention 100 showing the shapes that contain the motorcycle axle 14. The spacing of the opening for the motorcycle axle 14 is just larger than the largest diameter motorcycle axle. In the top view the angled surfaces associate with the angled surfaces 252 and 254, respectively. Together, these aid in containment of the motorcycle axle such that the inner, lower portion of each V contains smaller diameter axles and the outer, upper portion of each V contains larger diameter axles. The V-shaped sides 262 of the angled surface 252 and the V-shaped sides 264 of the angled surface 254 allow the invention to contain a motorcycle stand axle regardless of its diameter while forcing the axle to center in the main housing 100.

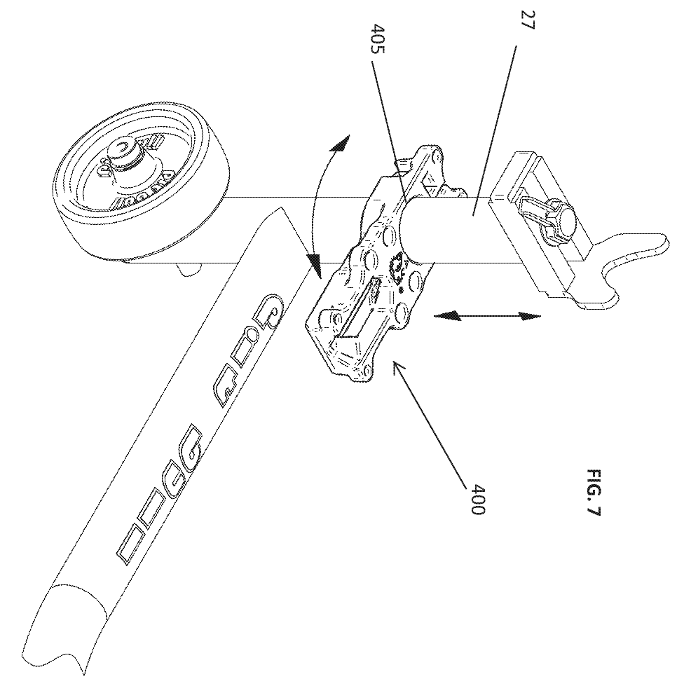

FIG. 7 shows an alternate design 400 that attaches to the (nearly) vertical structural tube 27. As indicated by the arrows, this allows the invention to be adjusted up and down as well as rotated and fixed about the tube 27. With this design, no clamping cap 120 would be required. The main body 110 would include a tube hole 405 such that to install this design the user slides the main body 110 down from the top of the tube 27.

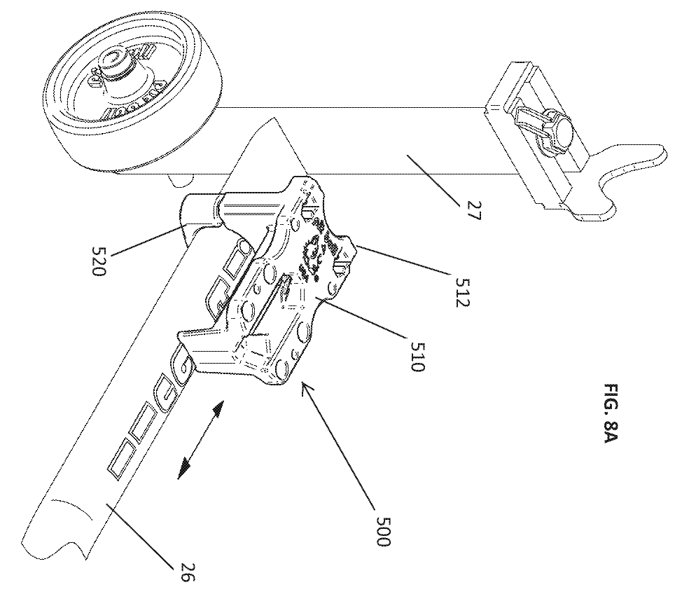

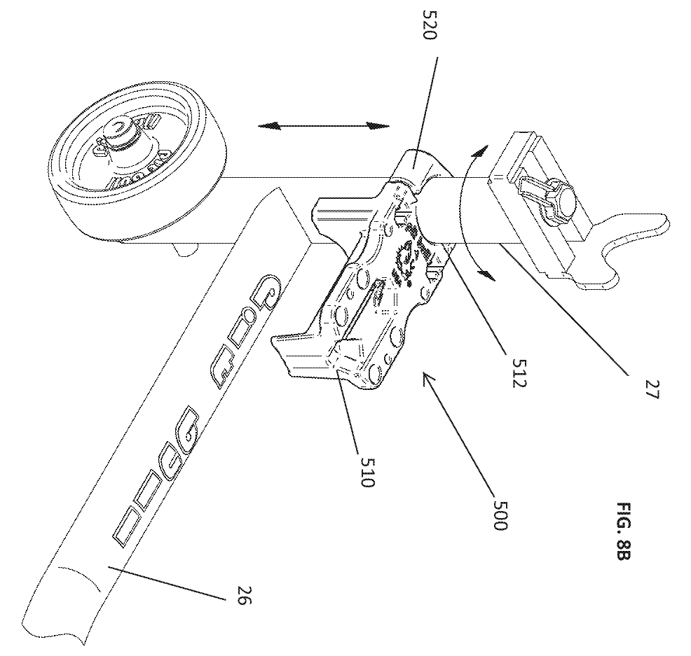

FIG. 8A and 8B show an alternate design 500 that is convertible to install on the horizontal (or nearly horizontal) structural tube or the vertical (or nearly vertical) structural tube. To attach to the tube 26, the clamp 520 is placed under the tube 26 and fastener screws are used to clamp it to the main body 510. To attach to tube 27, the clamp 520 is moved to the opposite side of tube 27 and fixed with fastener screws to the front face 512 of the main body 510. When attached to tube 26 as shown in FIG. 8A, the axle holder can be positioned close or farther away from vertical tube 27 as illustrated by the arrow. When attached to the vertical or nearly vertical tube 27, as shown in FIG. 8B, the axle holder can be positioned higher or lower and it can be positioned at various rotational positions as illustrated by the arrows.

In one embodiment there is a motorcycle axle holder for use with a motorcycle stand, wherein the motorcycle stand has a first cylindrical member extending from a substantially vertical cylindrical member and the motorcycle stand is configured to lift an end of a motorcycle off a surface for removal of a motorcycle axle and wheel therefrom. The motorcycle axle holder includes: (a) a main body having a front end with a cylindrical bore configured to receive the substantially vertical cylindrical member such that the main body is adjustable about the substantially vertical cylindrical member in a vertical direction and in a rotational direction; and (ii) an angle axle hole positioned in the main body and configured to receive and hold a first end of a motorcycle axle, such that when the first end of the motorcycle axle is positioned in the angle axle hole, a second end of the motorcycle axle distal to the first end creates bearing forces between the motorcycle axle and the angle axle hole such that a self-locking reaction force is generated between a surface of the cylindrical bore and the substantially vertical cylindrical member securing the motorcycle axle holder in a secure orientation.

The invention is complex in number and orientation of surfaces. It therefore lends itself to being molded of plastic.

1. A motorcycle axle holder for use with a motorcycle stand, wherein the motorcycle stand has a first cylindrical member extending from a substantially vertical cylindrical member and the motorcycle stand is configured to lift an end of a motorcycle off a surface for removal of a motorcycle axle and wheel therefrom, the motorcycle axle holder comprising:
a main body having a front end with a cylindrical bore configured to receive the substantially vertical cylindrical member such that the main body is adjustable about the substantially vertical cylindrical member in a vertical direction and in a rotational direction; and
an angle axle hole positioned in the main body and configured to receive and hold a first end of a motorcycle axle, such that when the first end of the motorcycle axle is positioned in the angle axle hole, a second end of the motorcycle axle distal to the first end creates bearing forces between the motorcycle axle and the angle axle hole such that a self-locking reaction force is generated between a surface of the cylindrical bore and the substantially vertical cylindrical member securing the motorcycle axle holder in a secure orientation.

2. The motorcycle axle holder of claim 1, wherein the angle axle hole includes a forward V-shaped side with a forward angled surface and a diametrically opposed rearward V-shaped side with a rearward angled surface.

3. The motorcycle axle holder of claim 2, wherein the main body further includes one or more of the following:
a set of holder holes, wherein the holder holes being configured to receive a second set of screws secured to the main body with nuts positioned on a top portion and bottom portion of the main body, such that a portion of the second set of screws extend above the main body;
a set of small holes, wherein the set of small holes are configured to hold pins;
at least two caliper holes, wherein the at least two caliper holes are configured to hold brake caliper screws; and
a blind hole configured to hold a screw.

4. The motorcycle axle holder of claim 3, wherein the counterbored holes are further configured to receive front axle end screws.

5. A motorcycle axle holder for use with a motorcycle stand, wherein the motorcycle stand has a first cylindrical member extending from a substantially vertical cylindrical member and the motorcycle stand is configured to lift an end of a motorcycle off a surface for removal of a motorcycle axle and wheel therefrom, the motorcycle axle holder comprising:
a main body having a circular opening bored there through, the circular opening configured to receive the substantially vertical cylindrical member of the motorcycle stand; and
an angle axle hole positioned in the main body and configured to receive and hold one end of a motorcycle axle.

6. The motorcycle axle holder of claim 5, wherein the main body further includes a set of counterbored holes, wherein the counterbored holes are configured to receive a set of fastener screws which extend into clamp holes defined on the clamp and secured by nuts that fasten the main body to the clamp.

7. The motorcycle axle holder of claim 6, wherein the main body further includes one or more of the following:
a set of holder holes, wherein the holder holes being configured to receive a second set of screws secured to the main body with nuts positioned on a top portion and bottom portion of the main body, such that a portion of the second set of screws extend above the main body;
a set of small holes, wherein the set of small holes are configured to hold pins;
at least two caliper holes, wherein the at least two caliper holes are configured to hold brake caliper screws; and
a blind hole configured to hold a screw.

8. The motorcycle axle holder of claim 6, wherein the counterbored holes are further configured to receive front axle end screws.

9. The motorcycle axle holder of claim 5, wherein the angle axle hole includes a forward V-shaped side with a forward angled surface and a diametrically opposed rearward V-shaped side with a rearward angled surface.

10. The motorcycle axles holder of claim 9, wherein the main body includes a substantially vertical surface adjacent to the angle axle hole, the vertical surface is configured to prevent the motorcycle axle from sliding forward and down when inserted into to angle axle hole.
